(19) United States
(12) Patent Application Publication
(10) Pub. No.: US 2013/0335361 A1
(43) Pub. Date: Dec. 19, 2013

(54) SYSTEMS AND METHODS FOR DISPLAYING DATA ON LARGE INTERACTIVE DEVICES

(71) Applicants: Glenn A. Wong, Foster City, CA (US); April Slayden Mitchell, San Jose, CA (US); Susie Wee, Palo Alto, CA (US); Mark C. Solomon, San Jose, CA (US)

(72) Inventors: Glenn A. Wong, Foster City, CA (US); April Slayden Mitchell, San Jose, CA (US); Susie Wee, Palo Alto, CA (US); Mark C. Solomon, San Jose, CA (US)

(21) Appl. No.: 14/001,750

(22) PCT Filed: Apr. 22, 2011
(86) PCT No.: PCT/US2011/033694

§ 371 Date: Aug. 27, 2013

(51) Int. Cl. G06F 3/01

(52) U.S. Cl. CPC G06F 3/017
USPC 345/173; 345/156

(57) ABSTRACT

A method for displaying data on a large interactive device is provided. The method can include detecting a cupped hands gesture including a first cupped hand and a second cupped hand proximate a LID display surface. The method can further include altering a first display parameter of a display object proximate the cupped hands gesture in response to the detection of the cupped hand gesture.

### BACKGROUND OF THE INVENTION

With the “digital revolution” in full swing, the penetration of large displays into the retail and commercial space continues to increase. Digital advertising displays in a retail space and flight information displays in airports are just two examples of non-interactive large displays providing data to a viewer. An evolutionary step in the growth of large displays, a large interactive display, or LID, provides the viewer with a unique ability to interact with the device, to select the data displayed on the device or to access desired content. One potential stumbling block to widespread public acceptance is the perception that private or confidential data displayed on the device, for example email, images, and video may be compromised by other individuals proximate to or using the large interactive device.

### DESCRIPTION OF THE DRAWINGS

Advantages of one or more disclosed embodiments may become apparent upon reading the following detailed description and upon reference to the drawings in which:

FIG. 1 is a flow diagram depicting an illustrative data display method, according to one or more embodiments described;

FIG. 2 is a flow diagram depicting another illustrative data display method, according to one or more embodiments described;

FIG. 3 is a flow diagram depicting yet another illustrative data display method, according to one or more embodiments described;

FIG. 4A is a schematic depicting an illustrative data display system, according to one or more embodiments described;

FIG. 4B is a schematic depicting the illustrative data display system in FIG. 4A with a cupped hands gesture, according to one or more embodiments described;

FIG. 4C is a schematic depicting the illustrative data display system in FIG. 4B with a translating cupped hands gesture, according to one or more embodiments described;

FIG. 4D is a schematic depicting the illustrative data display system in FIG. 4A with a rotated cupped hands gesture according to one or more embodiments described;

FIG. 5 is a flow diagram depicting an illustrative data display method, according to one or more embodiments described;

FIG. 6 is a flow diagram depicting another illustrative data display method, according to one or more embodiments described; and

FIG. 7 is a flow diagram depicting yet another illustrative data display method, according to one or more embodiments described.

### DETAILED DESCRIPTION

A large interactive device (LID) can support multiple contemporaneous user sessions. As LIDs appear more frequently in public settings, maintaining the privacy of personal or confidential data presents a significant issue. To increase public acceptance and use of the LID, a user should have the ability with a simple gesture to adjust one or more display parameters of any personal or confidential data they may be accessing to prevent disclosure of the information to another LID user or passers-by.

A method for displaying data on a large interactive device is provided. The method can include detecting a cupped hands gesture including a first cupped hand and a second cupped hand proximate a LID display surface. The method can further include altering a first display parameter of a display object proximate the cupped hands gesture in response to the detection of the cupped hand gesture.

A system for displaying data on a large interactive device is also provided. The system can include at least one display device and at least one sensor coupled to the processor. The at least one sensor can detect the presence of a cupped hands gesture proximate the display device. The system can further include logic, which when executed by the processor alters a first display parameter of a display object proximate the cupped hands gesture responsive to detection of the cupped hands gesture by the at least one sensor.

Another method for displaying data on a large interactive device is also provided. The method can include generating a display object for a user and displaying the display object on a LID proximate the user. The method can further include detecting a cupped hands gesture, comprising a first cupped hand and a second cupped hand, proximate a display surface of the LID by the user. The method can include altering a display parameter of the display object proximate the cupped hands gesture responsive to detecting the cupped hands gesture, the display parameter including at least one of: display object intensity, display object size, and display object sharpness.

As used herein, the term “display object” can refer to any media, streaming media, visual communication, or the like provided by a processor to a user via the display device. Display objects can include images, video, or any combination of images and video. Display objects can also include images containing text data in whole or in part.

As used herein, the term “display parameter” can refer to any criterion, value, or level affecting the visual display of data on the display device. Example display parameters include, but are not limited to: color, brightness, gamma, contrast, sharpness, size, location, or combinations thereof.

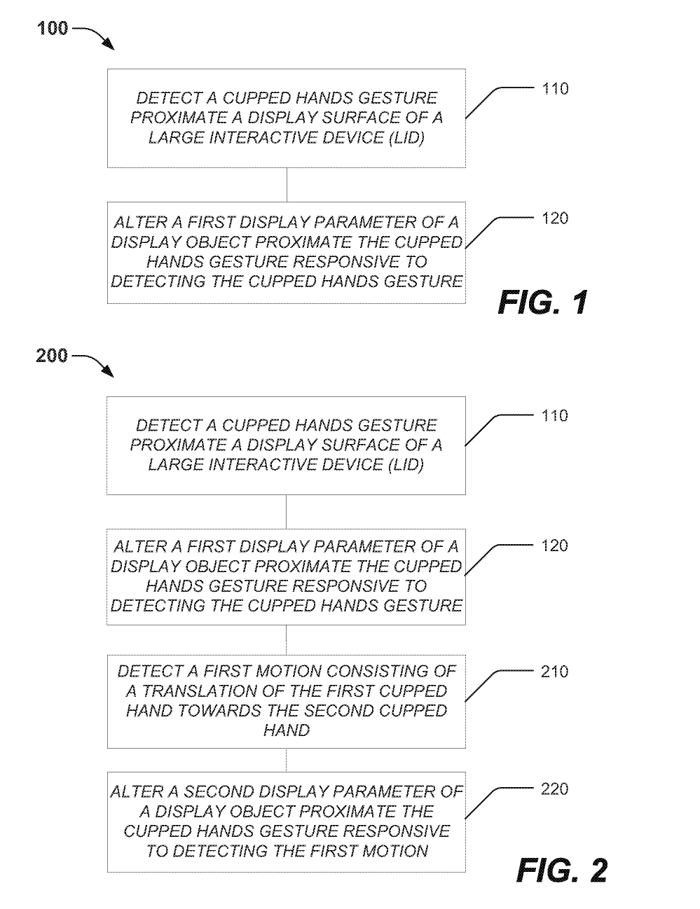

FIG. 1 is a flow diagram depicting an illustrative data display method 100, according to one or more embodiments. The method 100 can include detecting a cupped hands gesture proximate a display surface of a large interactive device (“LID”) at 110. The method 100 can also include altering a first display parameter of a display object proximate the cupped hands gesture responsive to detecting the cupped hands gesture at 120.

As a hypothetical exercise, envision a user accessing private or confidential information via a public LID. The user, sensing others around, desires to make the private or confidential information less accessible to those nearby. The method 100 can include the user making a cupped hands gesture proximate the LID display surface at 110. The cupped hands gesture can include a first cupped hand and a second cupped hand, for example a user cupping both a right (first) and a left (second) hand.

The cupped hands gesture can indicate a desire for limiting visibility of others, therefore making the gesture proximate the LID display surface may be considered an “intuitive” gesture indicating the user's desire to exclude others from viewing the display object. Since touch based and proximity sensors are available, the cupped hands gesture can be wither a “contact” type gesture on touch screen devices, or a “proximity” type gesture on devices capable of sensing objects proximate the display surface.

In response to detecting the cupped hands gesture at 110, the method can include altering a first display parameter of a display object proximate the cupped hands gesture at 120. The first display parameter can include, without limitation, at least one of the intensity of the display object, the size of the display object, and the sharpness of the display object. Altering the first display parameter can obscure or render unintelligible the display object proximate the user's cupped hands gesture. For example, in some embodiments, after the cupped hands gesture is detected by the LID, the intensity of the display object can be altered to make the display object indistinguishable or invisible when viewed against the LID display surface.

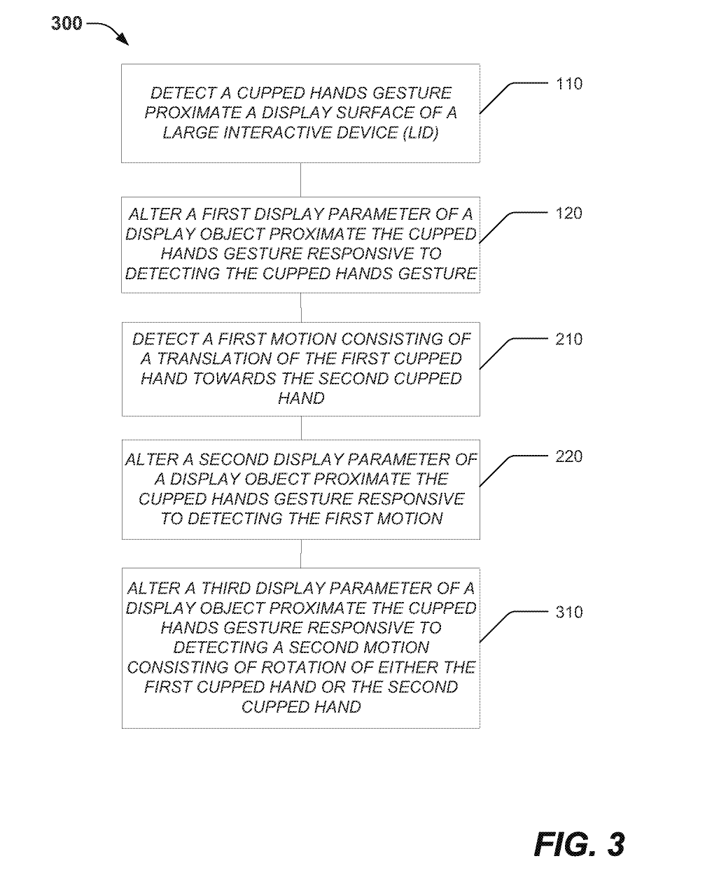

FIG. 2 is a flow diagram depicting another illustrative data display method 200, according to one or more embodiments. The method 200 depicted in FIG. 2 can include detecting a first motion consisting of a translation of the first cupped hand toward the second cupped hand at 210. The translation of the first hand towards the second hand reduces the distance separating the cupped hands. The user can translate one hand or both hands simultaneously to achieve a reduction in the distance between the two cupped hands.

In response to detecting the translation of the first cupped hand toward the second cupped hand at 210, the method can include altering a second display parameter of the display object proximate the cupped hands gesture at 220. The second display parameter can include, without limitation, at least one of the intensity of the display object, the size of the display object, and the sharpness of the display object. Altering the second display parameter can further obscure or render unintelligible the display object proximate the user's cupped hands gesture,

For example, in some embodiments, after the cupped hands gesture is detected by the LID, the intensity of the display object can be altered to make the display object indistinguishable or invisible when viewed against the LID display surface and after the translation of the first cupped hand towards the second cupped hand is detected the size of the display object can be reduced commensurate with the translation of the first cupped hand towards the second cupped hand. In so doing, both the intensity (the first display parameter) and the size (the second display parameter) can be altered in response to the detection of the cupped hands gesture and the translation of the first cupped hand towards the second cupped hand (respectively).

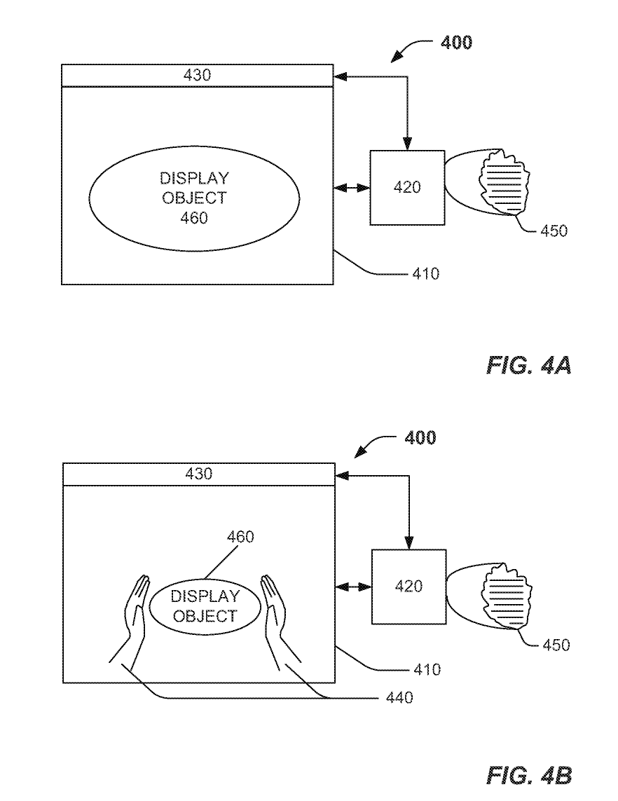

FIG. 3 is a flow diagram depicting yet another illustrative data display method 300, according to one or more embodiments. The method 300 depicted in FIG. 3 can include altering a third display parameter upon detecting a second motion consisting of a rotation of either the first cupped hand or the second cupped hand to a palm down gesture at 310. The third display parameter can include, without limitation, at least one of the intensity of the display object, the size of the display object, and the sharpness of the display object. Altering the third display parameter can additionally obscure or render unintelligible the display object proximate the user's cupped hands gesture.

For example, in some embodiments, after the cupped hands gesture is detected by the LID the intensity of the display object can be altered rendering the display object indistinguishable or invisible when viewed against the LID display surface; and, after the translation of the first cupped hand towards the second cupped hand is detected, the size of the display object can be reduced; the sharpness of the display image can then be reduced when the user rotates one of their cupped hands to a palm down gesture. In so doing, the intensity (the first display parameter), the size (the second display parameter), and the sharpness (the third display parameter) can ALL be altered in response to the detection of the cupped hands gesture, the translation of the first cupped hand towards the second cupped hand, and the rotation of the first or second cupped hand to a palm down position (respectively).

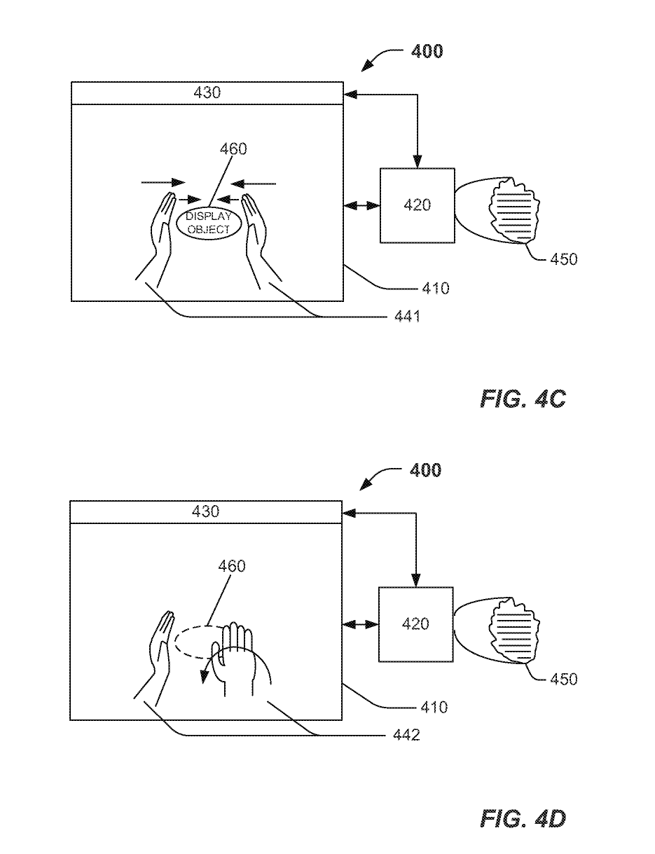

For clarity and ease of discussion, FIGS. 4A through 4D will be collectively discussed as a group. FIG. 4A is a schematic depicting an illustrative data display system 400, according to one or more embodiments. FIG. 4B is a schematic depicting the illustrative data display system in FIG. 4A with a cupped hands gesture, according to one or more embodiments. FIG. 4C is a schematic depicting the illustrative data display system in FIG. 4B with a translating cupped hands gesture (i.e., the first motion), according to one or more embodiments. FIG. 4D is a schematic depicting the illustrative data display system in FIG. 4A with a rotated cupped hands gesture (i.e., the second motion) according to one or more embodiments.

The system 400 as depicted in FIG. 4A can include at least one display device 410 coupled to a processor 420. At least one sensor 430 configured to detect at least in part a cupped hands gesture can be coupled to the processor 420. The system 400 can further include logic 450 which when executed by the processor 420, alters a first display parameter of a display object proximate the cupped hands gesture in response to the detection of the cupped hands gesture using the at least one sensor. The logic 450 can, when executed by the processor 420, alter a second display parameter of a display object proximate the translated first cupped hand gesture in response to the detection of the translated first cupped hand gesture using the at least one sensor. The logic 450 can, when executed by the processor 420, alter a third display parameter of a display object proximate the palm down cupped hand gesture in response to the detection of the palm down cupped hand gesture using the at least one sensor.

The at least one display device 410 can include any number of independent displays arranged in a regular or irregular array to provide a single large interactive device. The independent display or displays forming the at least one display device can use any existing or future display technology including, but not limited to, cathode ray tube (CRT) technology, light emitting diode (LED) technology, gas plasma technology, organic LED (OLED) technology, liquid crystal display (LCD) technology, three dimensional display technology, or any combination thereof.

In some embodiments, the at least one display device 410 can include a plurality of display devices, with each of the plurality of display devices disposed proximate at least one other of the plurality of display devices. For example the at least one display device can include nine (i.e., a plurality) 42″ LCD displays arranged in a 3×3 array.

The processor 420 can include one or more devices configured to execute a machine executable instruction set. In some embodiments, a single processor 420 can be used to generate graphical data for display on the LID and execute one or more machine executable instruction sets. In other embodiments, the processor 420 can include a plurality of processors, each having one or more dedicated functions, for example a central processing unit (CPU) executing a machine executable instruction set and a graphical processing unit (GPU) providing at least a portion of the graphical data displayed on the LID, The processor 420 can have any number of data inputs and any number of data outputs. For example, in at least some embodiments, the processor 420 can have a data input to accept sensor data generated by the at least one sensor 430. The processor 420 can be disposed at least partially within the at least one display device 410, In some embodiments, the processor 420 can be disposed within a housing external to the at least one display device 410.

The at least one sensor 430 can include any number of systems, devices, or any combination of systems and devices configured to detect the presence one or more gestures proximate the display device 410. In some embodiments, the at least one sensor can include a touch sensitive surface, for example a capacitive touch sensor, built in to the display device 410. In some embodiments, the at least one sensor can include one or more acoustic or electromagnetic based touch detection technologies housed within a bezel at least partially surrounding the display device 410.

The at least one sensor 430 can detect the presence of the cupped hands gesture 440 proximate the LID display surface as a plurality of continuous touches formed using the edge of the pinky finger and the palm. The at least one sensor 430 can detect the translation of one or both cupped hands gesture 441 on the display surface of the display device 410. The at least one sensor 430 can detect the palm down cupped hand gesture 442 on the display surface of the display device 410. The output generated by the at least one touch sensor 430 can be used to provide an input to the processor 420.

The processor 420 can execute a machine executable instruction set or logic 450 that alters a first display parameter of a display object 460 proximate the cupped hands gesture 440 responsive to detection of the cupped hands gesture by the at least one sensor 430.

FIGS. 4A through 4D demonstrate one example operation for the display of data on a LID system 400. Referring first to FIG. 4A, a user may access a private or confidential display object 460 using the LID system 400. The user may access the display object 460, for example, by initiating a user session and logging into a personal email account using the LID. As depicted in FIG. 4A, the display object appears proximate the user on the LID.

Referring next to FIG. 4B, the user has elected to make private the display object 460, perhaps in response to the approach of another individual, or perhaps in response to a second user initiating an independent session on the LID too close to the display object 460. To maintain the privacy of the display object 460, the user makes a cupped hands gesture 440 proximate display object 460. The sensor 430 detects the user's cupped hands gesture 440, triggering the transmission of a signal to the processor 420. In response to the sensor signal, the processor 420 can alter a first display parameter of the display object 460, for example reducing the intensity of the display object to match the surrounding LID surface, thereby making the display object nearly invisible.

Referring next to FIG. 4C, the user has elected to translate one or both cupped hands across the display surface of the display device 410, i.e., the user performs the first motion, a translated cupped hands gesture 441. The at least one sensor 430 detects the first motion 441, triggering the transmission of a signal to the processor 420. In response to the sensor signal, the processor 420 can alter a second display parameter of the display object 460, for example reducing the size of the display object 460 such that the display object 460 remains between the user's translated cupped hands.

Referring finally to FIG. 4D, the user has elected to rotate one of their cupped hands to a palm down position proximate the display surface of the display device 410, i.e., the user performs the second motion 442, a palm down cupped hand gesture 442. The at least one sensor 430 detects the second motion 442, triggering the transmission of a signal to the processor 420. In response to the sensor signal, the processor 420 can alter a third display parameter of the display object 460, for example reducing the sharpness or blurring the display object 460.

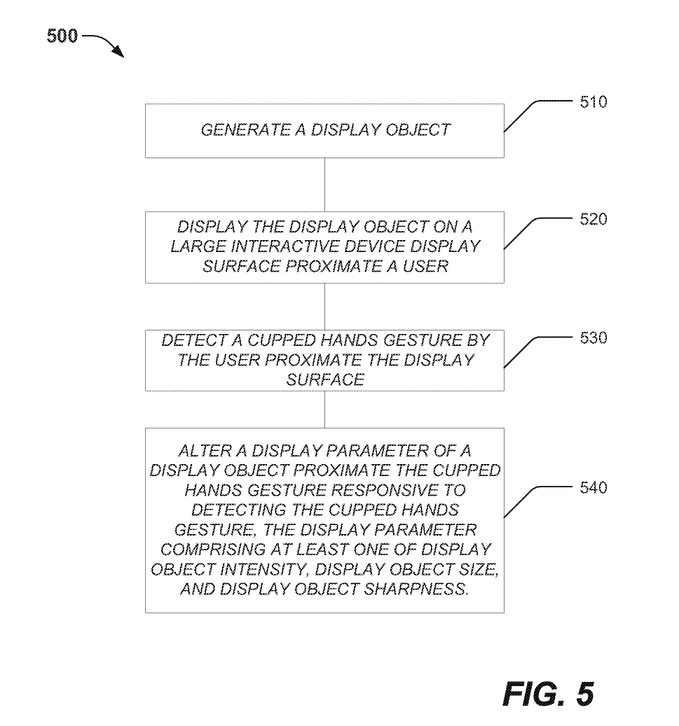

FIG. 5 depicts a flow diagram of an illustrative data display method 500, according to one or more embodiments. The method 500 can include generating a display object at 510, and displaying the display object on a LID proximate a user at 520. The method can further include detecting a cupped hands gesture by the user proximate a display surface of the LID at 530 using the at least one sensor 430. The method can also include altering a display parameter of a display object proximate the cupped hands gesture, where the display parameter includes at least one of display intensity, display object size, and display object sharpness at 540.

A display object can be generated at 510. The display object can include any one way (e.g., email) or two-way (e.g., video conference) communication between the user and the display device 410.

The display object can be displayed on the LID, proximate a user at 520. A cupped hands gesture can be detected on the display surface of the display device at 530. In at least some embodiments, the cupped hands gesture can be detected at 530 using a remote sensor disposed in a bezel surrounding the display device. In other embodiments the cupped hands gesture can be detected at 530 using a sensor integrated into the display surface, for example a capacitive touch sensor overlaying the display surface.

A display parameter associated with the display object can be altered responsive to the detection of the cupped hands gesture at 540. The altered display parameter can include at least one of: the display object intensity, the display object size, and the display object sharpness. Altering the display parameter at 540 can include, in some embodiments, adjusting the one or more display parameters to a predetermined value, for example, reducing the intensity, size, or sharpness of the display object by 50% in order to reduce the visibility or legibility of the display object.

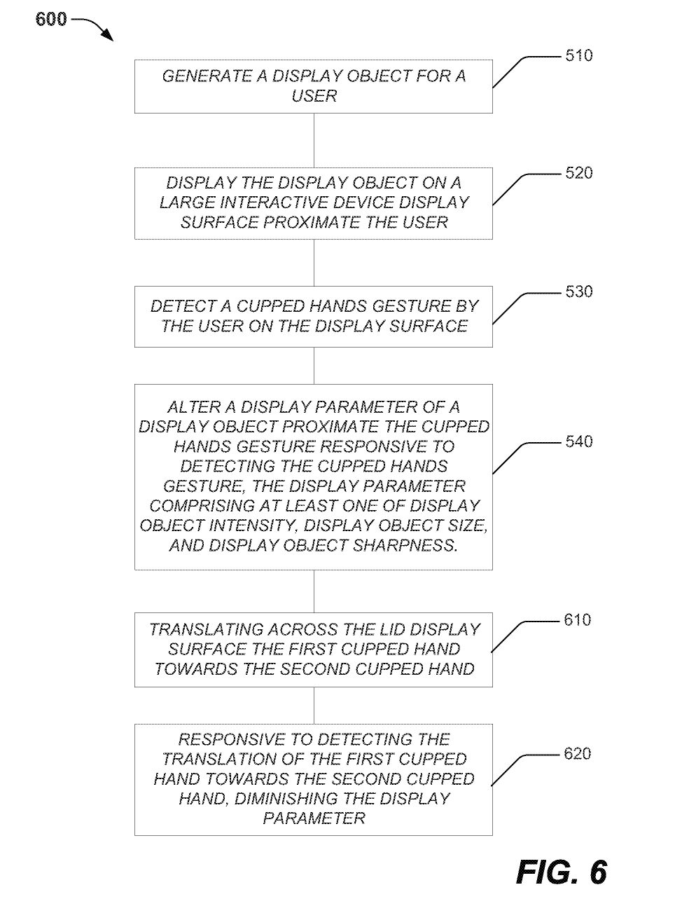

FIG. 6 depicts a flow diagram of another illustrative data display method 600, according to one or more embodiments. The method 600 can include detecting the translation of the user's first cupped hand towards the user's second cupped hand at 610. The method 600 can also include diminishing the display parameter in response to the detection of the translation of the user's hands towards each other at 620. In at least some embodiments, the diminution of the display parameter at 620 can be commensurate or proportionate to the reduction in distance between the user's first and second cupped hands as a result of the user's translation motion at 610.

Diminishing the display parameter in response to the detection of the translation of the user's hands towards each other at 620 can include further diminishing the intensity of the display object, further diminishing the size of the display object, or further diminishing the sharpness of the display object. Such reductions can further reduce the visibility or legibility of the display object, thereby increasing the privacy of the display object.

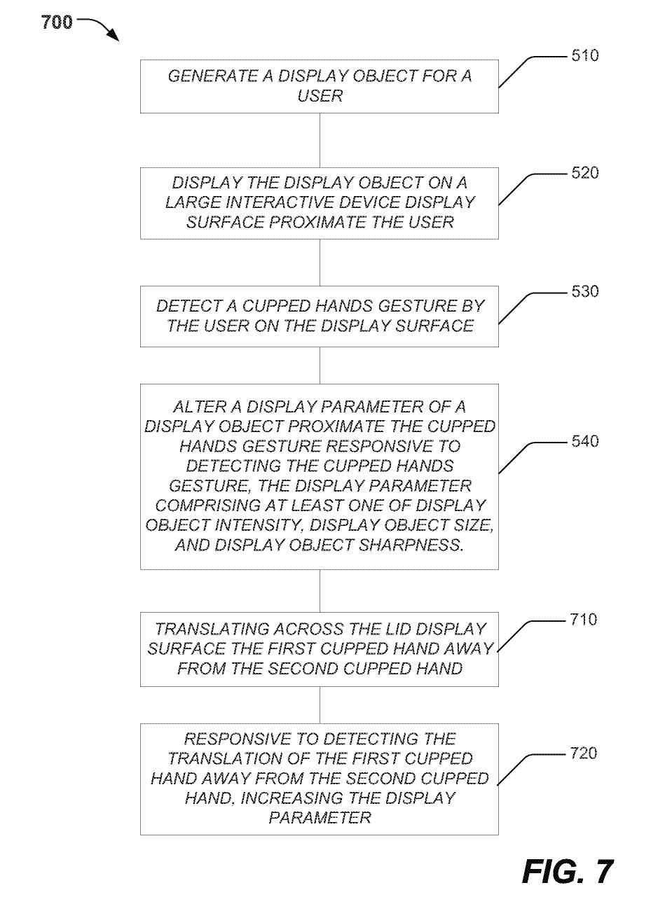

FIG. 7 depicts a flow diagram of yet another illustrative data display method 700, according to one or more embodiments. The method 700 can include detecting the translation of the user's first cupped hand away from the user's second cupped hand at 710. The method 700 can also include increasing the display parameter in response to the detection of the translation of the user's hands away from each other at 720. In at least some embodiments, the increase of the display parameter at 720 can be commensurate or proportionate to the increase in distance between the user's first and second cupped hands as a result of the user's translation motion at 710.

Increasing the display parameter in response to the detection of the translation of the user's hands away from each other at 720 can include increasing the intensity of the display object, increasing the size of the display object, or increasing the sharpness of the display object. Such increases can enhance the visibility or legibility of the display object, for example when the user desires to resume interaction with the display object.

Certain embodiments and features may have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

While the foregoing is directed to embodiments of the present invention, other and further embodiments of the invention may be devised without departing from the basic scope thereof, and the scope thereof is determined b the claims that follow.

The following is therefore claimed:

1. A method (100) for displaying data on a Large Interactive Device (LID), comprising:
detecting (110) a cupped hands gesture, comprising a first cupped hand and a second cupped hand, proximate a display surface of the LID; and
altering (120) a first display parameter of a display object proximate the cupped hands gesture responsive to detecting the cupped hands gesture.

2. The method of claim 1,
wherein the first display parameter comprises the intensity of the display object; and
wherein the intensity of the display object is reduced proportionate to the distance between the first cupped hand and the second cupped hand.

3. A method of claim 1, further comprising:
detecting (210) a first motion consisting of translating the first cupped hand towards the second cupped hand across the display surface of the LID; and
responsive (220) to detecting the first motion, altering a second display parameter.

4. The method of claim 3,
wherein the first display parameter comprises the intensity of the display object;
wherein the intensity of the display object is reduced proportionate to the distance between the first cupped hand and the second cupped hand;
wherein the second display parameter comprises the size of the display object; and
wherein the size of the display object is proportionate to the distance between the first cupped hand and the second cupped hand.

5. The method of claim 1,
wherein the first display parameter comprises the intensity of the display object; and
wherein the intensity of the display object is reduced to an extent rendering the display object invisible to a human eye.

6. The method of claim 1, further comprising:
altering (310) a third display parameter of a display object proximate the cupped hands gesture responsive to a second motion consisting of rotation of either the first cupped hand or the second cupped hand to a palm down gesture proximate the display surface of the LID.

7. The method of claim 6,
wherein the first display parameter comprises the intensity of the display object;
wherein the intensity of the display object is proportionate to the distance between the first cupped hand and the second cupped hand;
wherein the third display parameter comprises the sharpness of the display object on the display surface of the LID.

8. A system (400) for displaying data on a Large Interactive Device (LID), comprising:
at least one display device (410) coupled to a processor (420);
at least one sensor (430) coupled to the processor, the at least one sensor to detect the presence of a cupped hands gesture (440) proximate the display device; and
logic, (450) which when executed by the processor:
alters a first display parameter of a display object (460) proximate the cupped hands gesture responsive to detection of the cupped hands gesture by the at least one sensor.

9. The system of claim 8, wherein the at least one sensor (430) comprises a touch sensitive surface disposed proximate the at least one display device.

10. The system of claim 8, wherein the at least one sensor (430) comprises detector disposed at least partially within a bezel, the bezel at least partially surrounding the at least one display device.

11. The system of claim 8, further comprising:
logic, which when executed by the processor:
alters a second display parameter of the display object responsive to detection of a first motion (441) by the at least one sensor, the first motion consisting of translating the first cupped hand towards the second cupped hand across the display surface of the LID; and
alters a third display parameter of the display object responsive to detection of a second motion (442) by the at least one sensor, the second motion consisting of rotation of either the first cupped hand or the second cupped hand to a palm down gesture proximate the display surface of the LID.

12. The system of claim 8, wherein the at least one sensor (430) detects the presence of the cupped hands gesture as a plurality of continuous touches formed by the edge of the pinky finger and palm.

13. A method for displaying data on a Large Interactive Device (LID), comprising:
generating (510) a display object;
displaying (520) the display object on a LID proximate a user;
detecting (530) a cupped hands gesture, comprising a first cupped hand and a second cupped hand, proximate a display surface of the LID by the user;
altering (540) a display parameter of the display object proximate the cupped hands gesture responsive to detecting the cupped hands gesture, the display parameter comprising at least one of: display object intensity, display object size, and display object sharpness.

14. The method of claim 13, further comprising:
translating (610) across the LID display surface the first cupped hand towards the second cupped hand;
responsive to detecting the translation of the first cupped hand toward the second cupped hand, diminishing (620) the display parameter, comprising at least one of diminishing the display object intensity, diminishing the display object size, and diminishing the display object sharpness.

15. The method of claim 13, further comprising:
translating (710) across the LID display surface the first cupped hand away from the second cupped hand;
responsive to detecting the translation of the first cupped hand toward the second cupped hand, increasing (720) the display parameter, comprising at least one of increasing the display object intensity, increasing the display object size, and increasing the display object sharpness.
